(19) United States
(12) Patent Application Publication
(10) Pub. No.: US 2026/0316724 A1
(43) Pub. Date: Oct. 15, 2026

(54) MOBILE VERTICAL LIFT

(71) Applicant: Neil Beavers, Magnolia, OH (US)

(72) Inventor: Neil Beavers, Magnolia, OH (US)

(21) Appl. No.: 19/684,420

(22) Filed: May 21, 2026

Related U.S. Application Data
(63) Continuation of application No. 29/977,001, filed on Dec. 5, 2024, now Pat. No. D1127642.

(51) Int. Cl. B60S 9/10; E04H 15/00; E04H 15/06

(52) U.S. Cl. CPC B60S 9/10; E04H 15/001; E04H 15/06

(57) ABSTRACT

This invention discloses a towable vertical lift which is comprised of a frame, a deck which is affixed to the top of the frame, two front legs, two back legs, and wheels which are affixed to the frame, wherein the two front legs are attached to the frame with hinges which allow for the front legs to swivel from an upward position to a downward position, and wherein the back legs are attached to the frame with hinges which allow for the back legs to swivel from an upward position to a downward position. This towable vertical lift can be utilized as a towable vertical lifting hunting blind which is comprised of a frame, a deck, blind housing, a towing tongue, at least two wheels, and a mechanism for raising and lowering the deck.

This application claims benefit of U.S. Design patent application Ser. No. 29/977,001, filed on Dec. 5, 2024. The teachings of U.S. Design patent application Ser. No. 29/977,001 are incorporated herein by reference in their entirety.

### BACKGROUND OF THE INVENTION

In conducting various activities it is advantageous and sometimes critical to elevate personnel and/or equipment to accomplish a desired task. For instance, in building, painting, or otherwise refurbishing tall structures it is necessary for workers to be elevated to the level where the work needs to be carried out. In doing so, scaffolds are sometimes built to facilitate such work. Scaffolds can provide a stable horizontal platform to support workers and equipment at an elevated level. However, scaffolds are time consuming to construct at the site where the work is being done and must be transported on a truck or a trailer to the work site. It is, of course, necessary to unload the components of the scaffold for assembly at the work site and after the job has been completed to disassemble the scaffold and to load its components back onto a truck or trailed for shipment to another location. Scaffolds are not used as much today as they were in the past because of the high labor requirements associated with their transportation, assembly, and disassembly.

Today various types of lift trucks, such as boom lift trucks and bucket trucks, are widely used in untold applications. For instance, lift trucks are widely used in repairing electrical power lines, telephone lines, and cable lines which are situated high on utility poles. Lift trucks are also commonly used in constructing and repairing buildings and other structures where it is necessary to work above ground level as well as in trimming trees and tree removal. However, lift trucks are expensive and are not practical for use in many applications. For example, in some applications lift trucks are too large to be maneuvered into a desired location or do not provide a suitable platform for conducting the desired activity.

Towable boom lifts have the advantage of not requiring a truck onto which the boom lift is permanently attached. For this reason, towable boom lifts are typically less expensive than lift trucks. However, they do require a truck or some other suitable vehicle to tow them to a desired location. They also cannot be used in some applications due to their size. Towable boom lifts can also only be used in areas wherein the ground or some other supporting surface is relatively level to provide a safe base to support them.

Scissor lifts are well suited for work on walls, and can normally be transported on the beds of trucks or on trailers. Some scissor lifts have flat bases and are small enough to the carried to desired locations. More sophisticated scissor lifts are equipped with wheels to facilitate moving them into desired locations. Scissor lefts, such as Skyjack® scissor lifts, can essentially be driven into desired locations. However, scissor lifts require relatively level locations and are not suitable for use in remote locations. Scissor lifts also provide a work platform of limited area which is not suitable for supporting some desired equipment and accessories.

There is a need for a lift that is highly maneuverable and which can be towed over rough terrain and through narrow passages. Additionally, it would be highly desirable for the lift to be capable of being used on uneven or irregular surfaces and for it to be capable of serving multiple purposes. For instance, a lift that could serve the purpose of a trailer for hauling equipment or cargo as well as functioning as a lift for facilitating work activities. It would be even more desirable if the lift could be used for recreational purposes, such as a hunting stand or a hunting blind.

### SUMMARY OF THE INVENTION

The subject invention relates to a mobile vertically lifting stand which can be used for multiple purposes. More specifically, the mobile vertical lift of this invention is particularly amenable for use as a platform for a hunting blind or a hunting stand. It can also be beneficially used in the performance a wide variety of construction, repair, and other work activities that would normally be done using a ladder, scaffold, or some kind of lift. Additionally, the mobile vertical lift of this invention can also be used as a trailer for transporting equipment and cargo. In any case, the mobile vertical lift of this invention can be used for both work and for recreation.

The mobile vertical lift of this invention has particular utility as a platform for a hunting blind or hunting stand because it can be hitched onto a truck or car and hauled over highways and roads to a desired location. Optionally, it can be configured to carry an all-terrain vehicle (ATV) on its bed which can be unloaded and then used to further pull the mobile vertical lift over rugged terrain to a more remote location.

This invention more specifically discloses a towable vertical lift comprising a frame, wherein the frame has an upper side, a lower side, a front end and a back end; a deck which is affixed to the upper side of the frame; a first back leg; a second back leg; a first front leg; a second front leg; an articulating rear foot which extends from the bottom of the first back leg to the bottom of the second back leg; a first wheel which is attached to the first back leg; a second wheel which is attached to the second back leg; a towing tongue having a first end which is affixed to the front of the frame and a second end having a ball hitch affixed thereto; a first linear actuator which is attached to the frame and to the first back leg; a second linear actuator which is attached to the frame and to the second back leg; a third linear actuator which is attached to the frame and to the first front leg; and a fourth linear actuator which is attached to the frame and to the second front leg. The actuators in the towable vertical lift of this invention are hydraulic rams which are powered with a hydraulic power supply, wherein the hydraulic power supply is comprised of a hydraulic pump, a hydraulic fluid reservoir, and a battery. The towable vertical lift of this invention will also typically include a torsion axel which extends between the first wheel and the second wheel and which is attached to the first back leg and the second back leg.

The subject invention additionally reveals a towable vertical lift which is comprised of a frame, a deck which is affixed to the top of the frame, two front legs, two back legs, and wheels which are affixed to the frame, wherein the two front legs are attached to the frame with hinges which allow for the front legs to swivel from an upward position to a downward position, and wherein the back legs are attached to the frame with hinges which allow for the back legs to swivel from an upward position to a downward position.

The present invention further discloses a towable vertical lifting hunting blind which is comprised of a frame, a deck, blind housing, a towing tongue, two wheels, and a means for raising and lowering the deck.

### BRIEF DESCRIPTION OF THE DRAWINGS

FIG. 1 is a top right side perspective view of the mobile vertical lift of this invention.

FIG. 2 is a bottom perspective view of the mobile vertical lift of this invention.

FIG. 3 is right side view of the mobile vertical lift of this invention.

FIG. 4 is top view of the mobile vertical lift of this invention.

FIG. 5 is a bottom view of the mobile vertical lift of this invention.

FIG. 6 is a back side view of the mobile vertical lift of this invention.

FIG. 7 is a front view of the mobile vertical lift of this invention.

FIG. 8 is a top right side perspective view of the mobile vertical lift of this invention with an all-terrain vehicle mounted thereon.

FIG. 9 is a top right side perspective view of the mobile vertical lift of this invention with the mobile vertical lift being attached to an all-terrain vehicle.

FIG. 10 a top right side perspective view of the mobile vertical lift of this invention with the platform of the mobile vertical lift being in an elevated position.

FIG. 11 is a bottom right side perspective view of the mobile vertical lift of this invention with the platform of the mobile vertical lift stand being in an elevated position.

FIG. 12 is right side view of the mobile vertical lift of this invention with the platform of the mobile vertical lift being in an elevated position.

FIG. 13 is a top view of the mobile vertical lift of this invention with the platform of the mobile vertical lift being in an elevated position.

FIG. 14 is a bottom view of the mobile vertical lift of this invention with the platform of the mobile vertical lift being in an elevated position.

FIG. 15 is a back view of the mobile vertical lift of this invention with the platform of the mobile vertical lift being in an elevated position.

FIG. 16 is a front view of the mobile vertical lift of this invention with the platform of the mobile vertical lift stand being in an elevated position.

FIG. 17 is a top right side perspective view of the mobile vertical lift of this invention with the platform of the mobile vertical lift being in an elevated position and with a ladder being attached thereto.

FIG. 18 is a top right side perspective view of the mobile vertical lift of this invention with the platform of the mobile vertical lift stand being in an elevated position and with a blind being mounted on the platform of the mobile vertical lift stand.

FIG. 19 is a top right side perspective view of the mobile vertical lift of this invention with the platform of the mobile vertical lift stand being in an elevated position, and with the legs of the mobile vertical lift stand being in a fully extended position, and with a blind being on the platform of the mobile vertical lift stand.

The reference numerals shown in the drawing are as follows:
1—mobile vertical lift
2—front legs
3—back legs
4—deck
5—frame
6—power supply
7—wheels
8—tires
9—trailer tongue
10—trailer tongue ball hitch
11—towing jack
12—dolly wheel
13—hand crank
14—right front foot
15—left front foot
16—right side support
17—left side support
18—frame cross members
19—torsion axel
20.—first wheel
21—second wheel
22—first back leg
23—second back leg
24—side marker light
25—rear leg assembly
26—control box
27—electrical control line
28—tie downs
29—wheel fenders
30—articulating castors
31—tail lights
32—all-terrain vehicle
33—vehicle ramp
34—linear actuators
35—rods
36—cylinders
37—articulating rear feet
38—hinges
39—ladder
40—hunting blind
41—inside actuator element
42—outside actuator element

### DETAILED DESCRIPTION OF THE INVENTION

The mobile vertical lift of this invention is designed to be towed by a truck, an automobile, or any other suitable vehicle over roads, highways, fields, and other types of terrain to a desired location for use in work applications or for recreational purposes. It is accordingly equipped with trailing tongue which is attached at one end to the front of the frame of the vertical lift and with a trailer tongue hitch being at the opposite end of the towing tongue. The hitch will typically be a conventional ball hitch, such as a standard 2 inch ball (50.8 mm) hitch or in the alternative can be 1⅞ inch (47.6 mm), 2 5/16 inch, (58.7 mm), or 3 inch (76.2 mm) ball hitch. In any case, the towing tongue will be configured to attach to a conventional towing hitch to enable it to be pulled to a desired location. The towing tongue will preferably be a swing tongue and can optionally be an off-road hitch which is capable of swiveling 360° in pitch and roll to accommodate extreme angles between the tow vehicle and vertical lift being towed. The towing tongue will preferably include a trailer jack which can be raised and lowered with a hand crank or which can be powered with an electric motor. The towing jack can also optionally include a dolly wheel or can be equipped with a jack foot.

While being transported the legs of the vertical lift will be extended upward in a manner whereby they do not contact with the ground or pavement. On the other hand, the deck of the vertical lift is moved upwardly by extending the legs of the lift downwardly into a position where they contact the ground to support the lift in a stable manner. The legs of the vertical lift are typically moved up and down by actuators which are normally hydraulic rams or worm gear actuators. In the case where the legs are powered by hydraulic rams the vertical lift will include a hydraulic power supply with one or more batteries, a hydraulic pump, and a reservoir for hydraulic fluid. The batteries are can be charged from the power supply of vehicle used to tow the lift and the lift can optionally include solar panels to recharge the batteries.

The vertical lift will typically be comprised of a metal, such as steel or aluminum. Aluminum is preferred in many cases due to its relatively low weight and resistance to corrosion. Stainless steel is also a good choice due to its corrosion resistance and high strength. However, to reduce costs the main components of the vertical lift can be made with a wide variety of carbon steels. In any case, the main components of the vertical lift including its frame, its deck, its legs, its wheels, and its torsion axel will typically be comprised of a suitable metal.

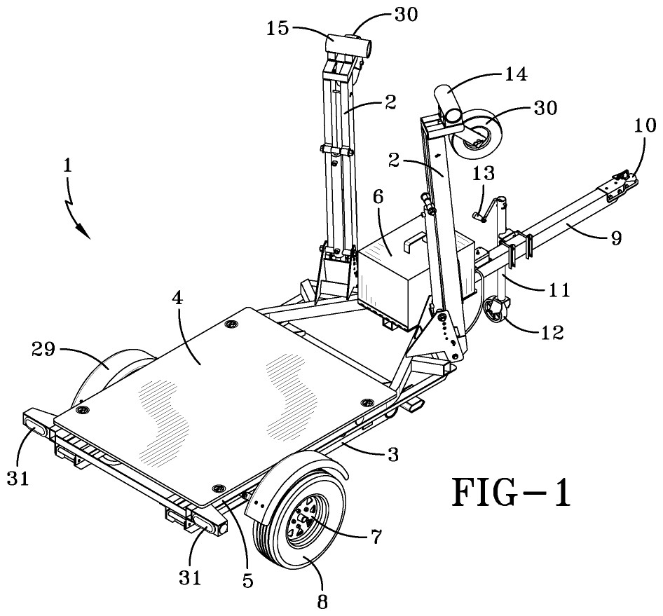

FIG. 1 is a top right side perspective view of the mobile vertical lift 1 of this invention wherein the front legs 2 and the back legs 3 are in an upward position and oriented in a manner whereby they do not contact the ground or pavement. This is the position in which the front legs 2 and back legs 3 would be oriented to transport the vertical lift 1.

As illustrated in FIG. 1, the front legs 2 of the lift 1 include front feet 14 which include 360° articulating castors 15. FIG. 1 also shows the deck 4 of the vertical lift 1 which a substantially flat platform which is affixed to the frame 5 of the lift 1. As illustrated in FIG. 1 the lift 1 also includes a power supply 6 for actuators, such as hydraulic rams or worm gear actuators. As illustrated in FIG. 1 the vertical lift 1 also has wheels 7 with tires 8 mounted thereon. As previously noted, the vertical lift 1 also includes a trailer tongue 9 which is attached to the front of the frame 3. The trailer tongue 9 will normally include a trailer tongue ball hitch 10 and a towing jack 11 which can optionally include a dolly wheel 12. The towing jack 11 will normally include a hand crank 13 for raising and lowering the jack 11 or could optionally include an electric motor (not shown) for raising and lowering the jack 11.

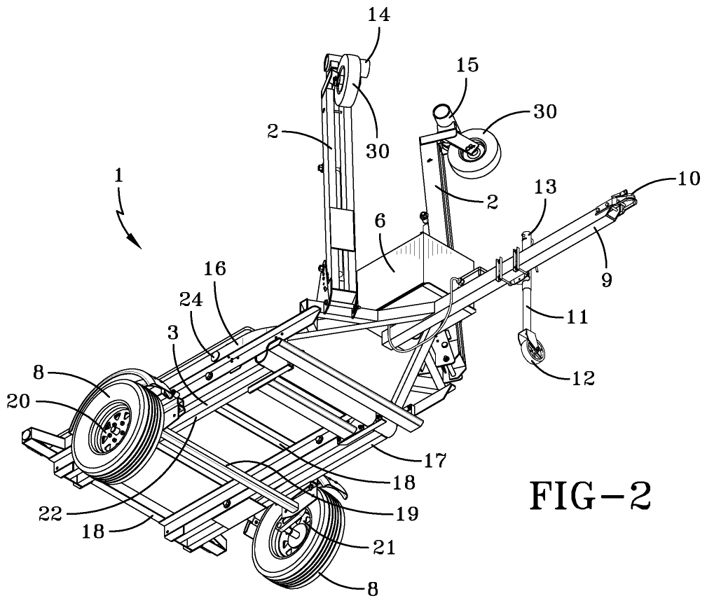

FIG. 2 is a bottom perspective view of the mobile vertical lift 1 of this invention wherein the front legs 2 and the back legs 3 are in an upward position and oriented in a manner whereby they do not contact the ground or pavement. FIG. 1 illustrates the frame 3 of the lift 1 wherein the frame 3 includes a right side support 16, a left side support 17, and a plurality of frame cross members 18. FIG. 2 also illustrates a torsion axel 19 which extends between the first wheel 20 and the second wheel 21 and which is attached to the first back leg 22 and the second back leg 23. A side marker light 24 which is typically of an amber color and which is affixed to the right side support 16 or the frame 3 is also illustrated in FIG. 2.

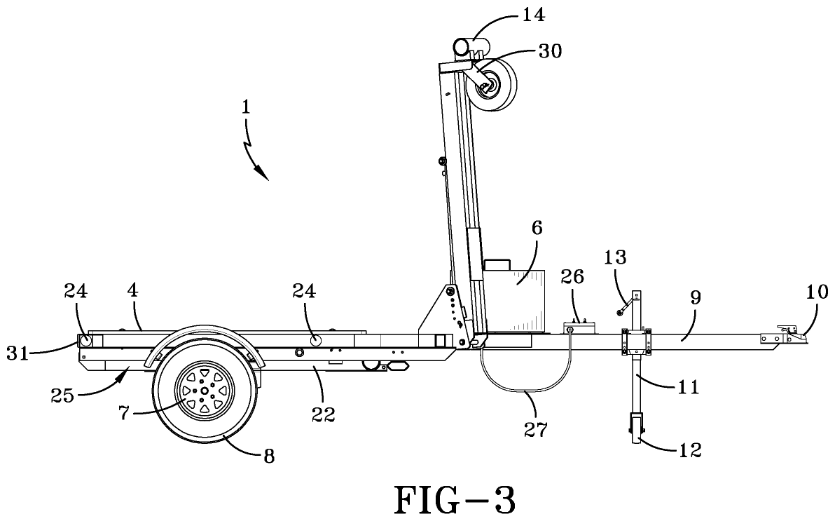

FIG. 3 is right side view of the mobile vertical lift of this invention, it illustrates the lift 1 with the front legs 2 and the back legs 3 being in an upward position and oriented in a manner whereby they do not contact the ground or pavement. In this view the rear leg assembly 25 and the front legs 2 can be seen in their full upward positions. The vertical lift 2 can also include a control box 26 for directing the position of the front legs 2 and the rear legs assembly 25. The control box 26 can be hard wired to the power supply via an electrical control line 27 or it can optionally position the front legs 2 and the rear legs assembly 25 by remote control.

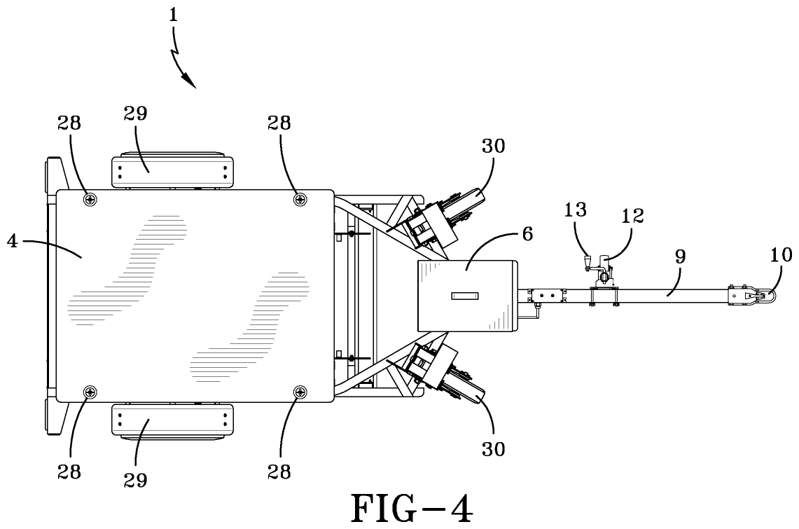

FIG. 4 is top view of the mobile vertical lift 1 of this invention, it illustrates the lift 1 with the front legs 2 and the back legs 3 being in an upward position and oriented in a manner whereby they do not contact the ground or pavement. It shows a deck 4 with tie downs 28 or attachment hooks which can be uses for securing equipment, a hunting blind, or the desired articles to the deck 4. As can be seen, the wheel fenders 29 which are attached to the frame 5 and cover the top portion of the wheels when the lift 1 is in the down position.

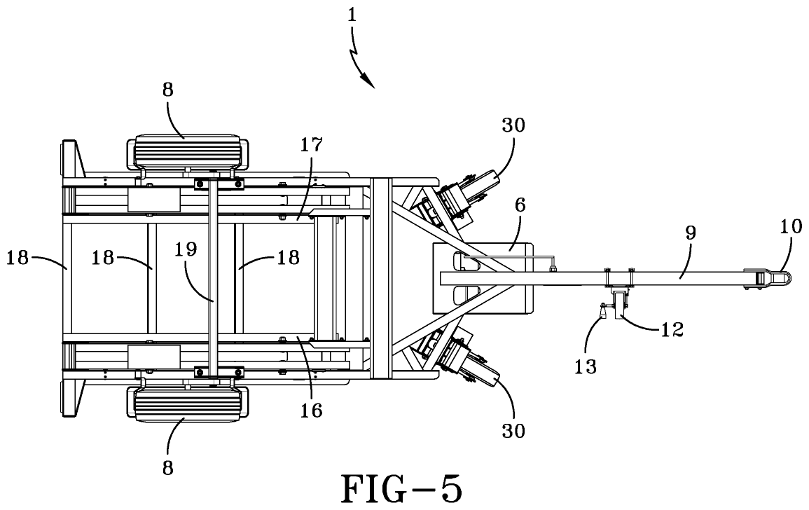

FIG. 5 is a bottom view of the mobile vertical lift 1 of this invention which illustrates the lift 1 with the front legs 2 and the back legs 3 being in an upward position and oriented in a manner whereby they do not contact the ground or pavement. The frame 5 which includes a right side support 16, a left side support 17, and a plurality of frame cross members 18 is clearly illustrated in this view. This view also more clearly shown the torsion axel 19 which extends between first back leg 22 and the second back leg 23 of the lift 1.

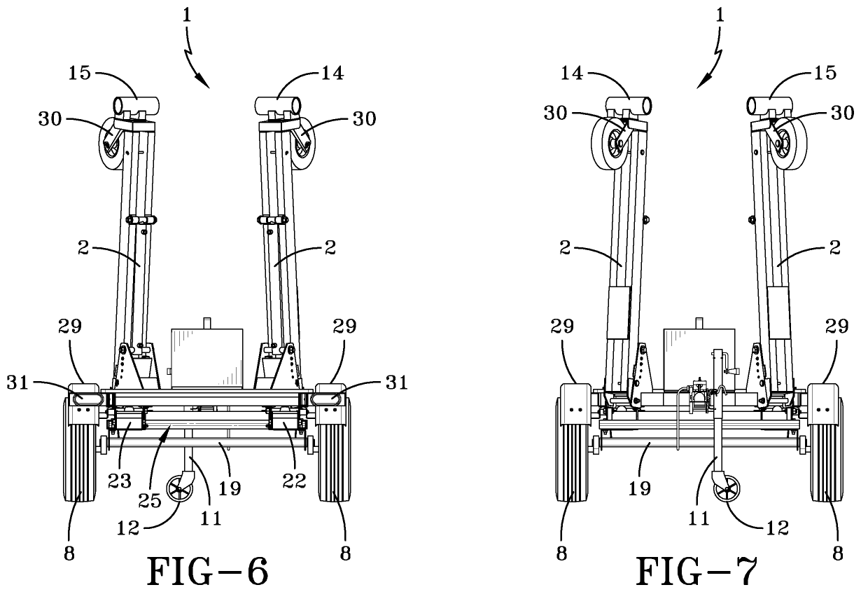

FIG. 6 is a back side view of the mobile vertical lift 1 wherein the front legs 2 and the back legs 3 are in an upward position and oriented in a manner whereby they do not contact the ground or pavement. This view shows red tail lights 31 which are affixed to both sides of the back of the frame 5. FIG. 7 is a front view of the mobile vertical lift 1 wherein the front legs 2 and the back legs 3 are in an upward position and oriented in a manner whereby they do not contact the ground or pavement. In this view the dolly wheel 12 of the towing jack 11 is extended to bring it into contact with the ground to support the front of the vertical lift 1.

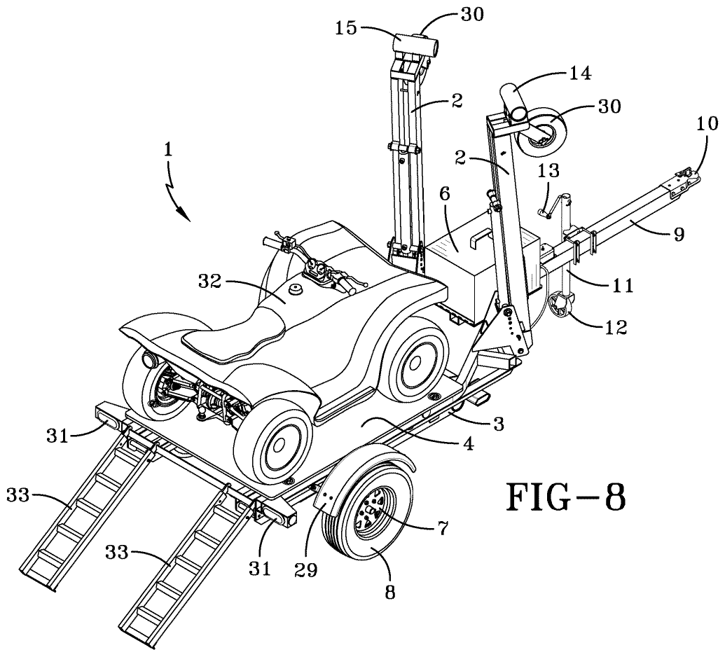

FIG. 8 is a top right side perspective view of the mobile vertical lift 1 of this invention with an all-terrain vehicle 32 mounted thereon. In this particular embodiment of the invention the vertical lift 1 includes a vehicle ramp 33 to facilitate loading and unloading of various vehicles onto and off of the deck 4 of the lift 1. The vehicles that can be transported on the lift 1 include various types of all-terrain vehicles 32, motorcycles, bicycles, 3-wheelers, 4-wheelers, and side-by-sides. The vehicle ramp 33 can be detachable or can be designed to conveniently slide under the frame 5 of the lift 1.

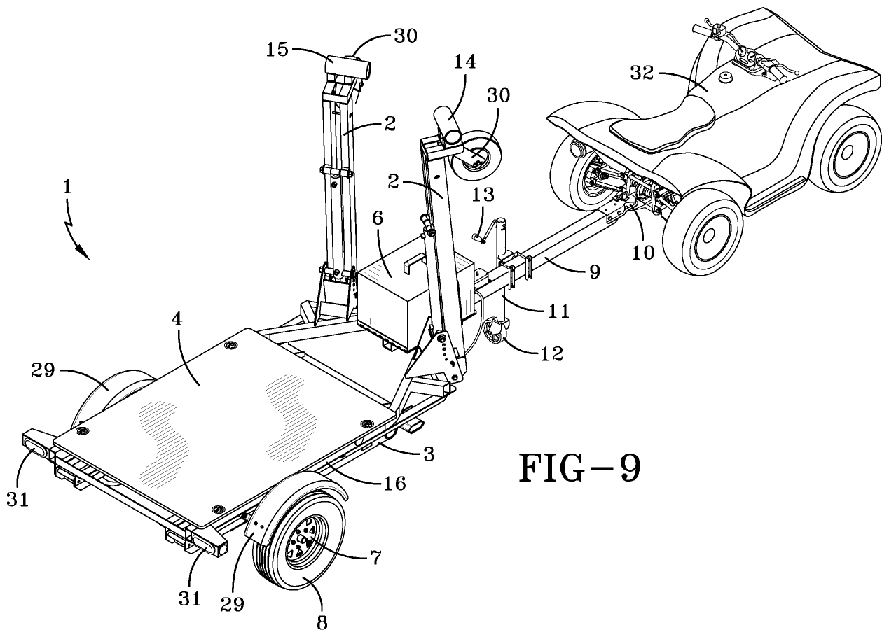

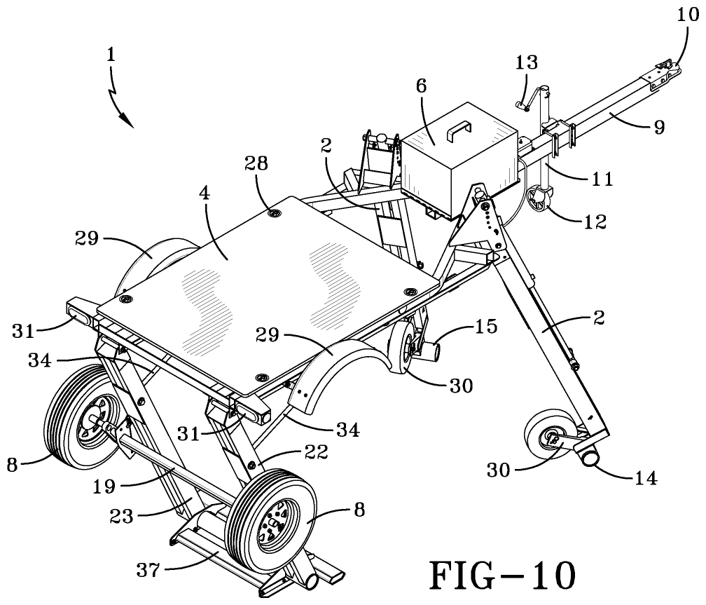

FIG. 9 is a top right side perspective view of the mobile vertical lift 1 with the mobile vertical lift 1 being attached to an all-terrain vehicle 32. This feature of the lift 1 allows it to be pulled over highways, roads, and other paved and unpaved surfaces to a desired location with the all-terrain vehicle 32 then being unloaded and subsequently used to pull the lift over rugged terrain to a location for its desired used, such as hunting.

FIG. 10 a top right side perspective view of the mobile vertical lift 1 of this invention with the deck 4 of the mobile vertical lift 1 being in an elevated position. As can be seen, the first back leg 22, the second back leg 23, and the front legs 2 are positioned downwardly to elevate the deck 4 of the lift 1. This view also more clearly shows the articulating rear foot 37 which extends between the bottom of the first back leg 22 and the second back leg 23. In this position the first front legs 2 are in a fully extended downward position. The front legs 2 are designed to permit up to 180° of travel from the upright position (as illustrated in FIGS. 1-9). The front legs 2 and the back legs 3 can vary greatly in length depending upon how high it desired for the deck 4 to be lifted above ground level. However, the front legs 2 and the back legs 3 will typically be about 5 feet to 12 feet long and will more typically be about 6 feet to about 8 feet long. The front legs 2 and the back legs 3 of the lift 1 are attached to the frame of the lift 1 through hinges 38 which allow the front legs 2 and the back legs 3 to swivel upwardly and downwardly to raise and lower the deck 4 of the lift 1.

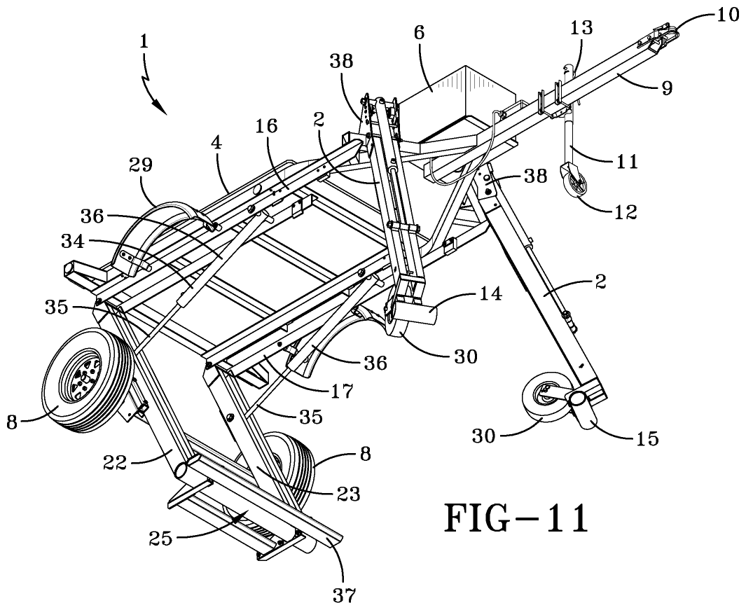

FIG. 11 is a bottom right side perspective view of the mobile vertical lift 1 of this invention with the deck 4 of the mobile vertical lift stand 1 being in an elevated position. This is position is achieved by extending the rods 35 out from the cylinders 36 of the linear actuators 34. The linear actuators 34 are typically hydraulic rams, but can optionally be worm-gear actuators.

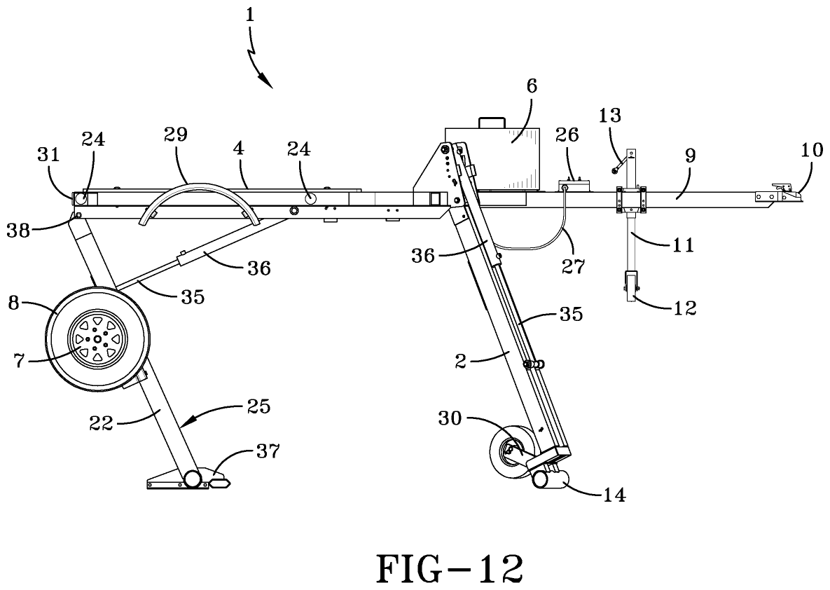

FIG. 12 is right side view of the mobile vertical lift 1 of this invention with the deck 4 of the mobile vertical lift 1 being in an elevated position. This view illustrates the rods 35 of the linear actuators 34 being extended out of the cylinders 36 of the linear actuators 34 so as to push back legs 3 and the front legs 2 downwardly to push the deck 4 of the lift 1 upwardly. The rods 35 will typically be capable of extending out of the cylinders 36 a distance of about 6 inches to about 36 inches, preferable about 12 inches to about 30 inches, and more preferably about 18 inches to about 28 inches. In many cases a hydraulic ram having rods 35 which are capable to extending out of their cylinders a distance of about 24 inches will be utilized.

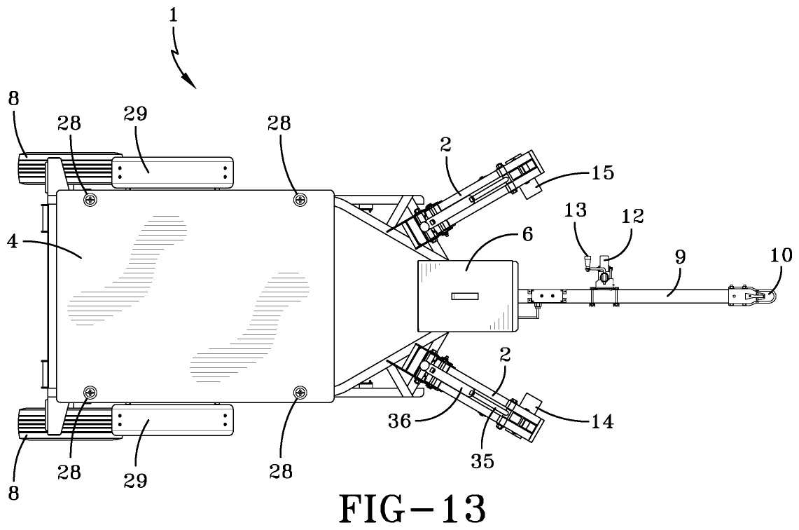

FIG. 13 is a top view of the mobile vertical lift 1 with the deck 4 of the mobile vertical lift being in an elevated position. This view shows the position of the front legs 2, the right front foot 14, the left front foot 15, and the articulating castors 30 when the deck 4 of the lift 1 is in an elevated position.

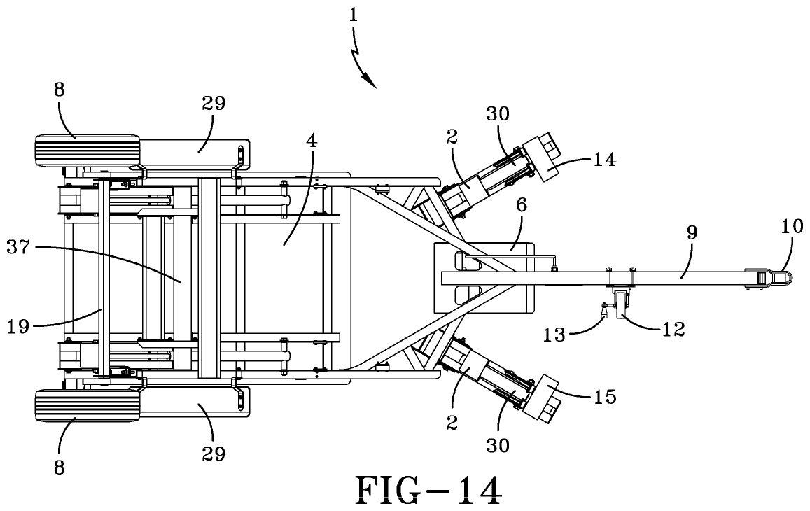

FIG. 14 is a bottom view of the mobile vertical lift 1with the deck 4 of the mobile vertical lift 1 being in an elevated position. This view illustrates the position of the articulating rear foot 37, the front legs 2, the right front foot 14, the left front foot 15, and the articulating castors 30 when the deck 4 of the lift 1 is in an elevated position.

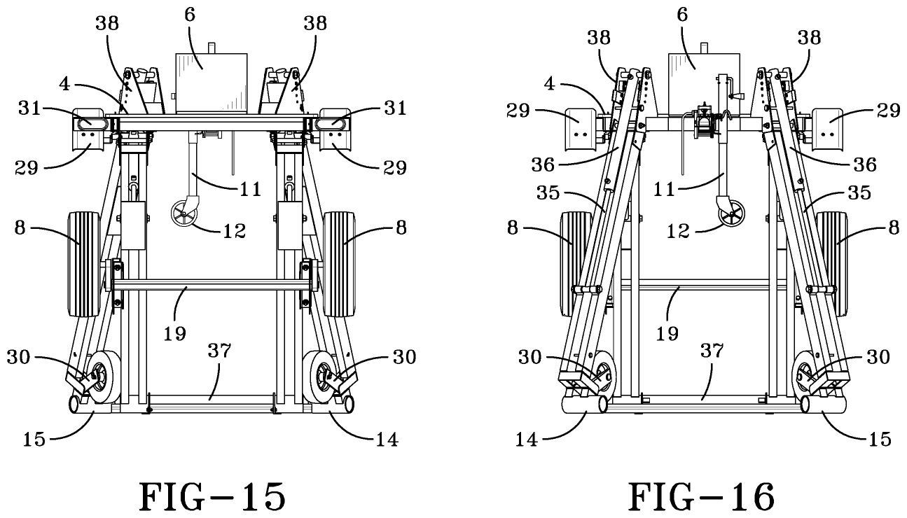

FIG. 15 is a back view and FIG. 16 is a front view of the mobile vertical lift 1 with the deck 4 of the lift 1 being in an elevated position. These views illustrates the position of the articulating rear foot 37, the front legs 2, the right front foot 14, the left front foot 15, and the articulating castors 30 when the deck 4 of the lift 1 is in an elevated position.

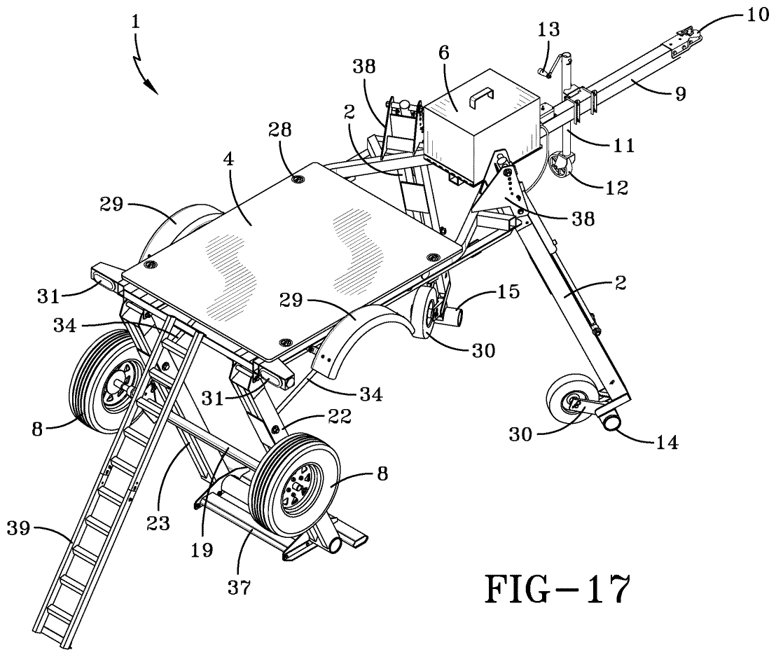

FIG. 17 is a top right side perspective view of the mobile vertical lift 1 with the deck 4 of the lift 1 being in an elevated position and with a ladder 39 being attached thereto. The ladder can optionally be a collapsible ladder or it can be configured to conveniently slide under the frame 5 of the lift 1.

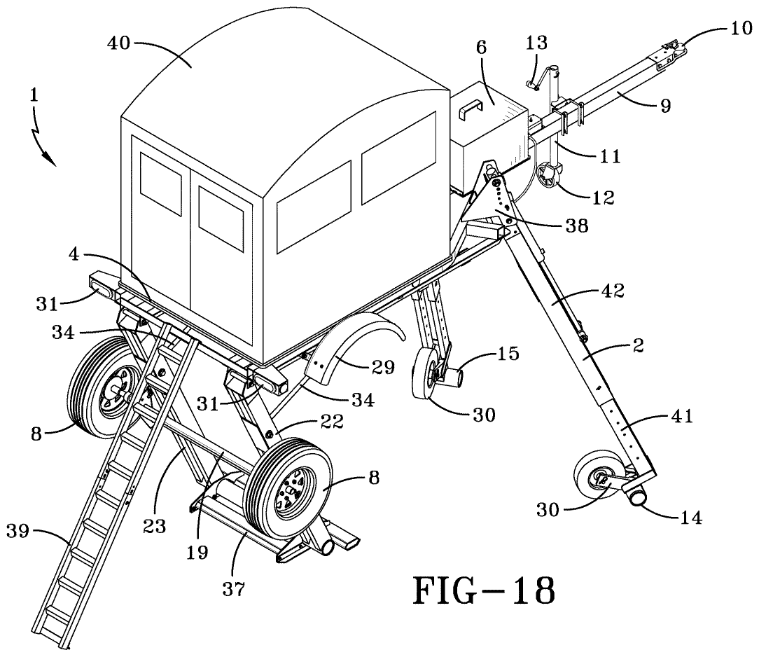

FIG. 18 is a top right side perspective view of the mobile vertical lift 1 of this invention with the deck 4 of the mobile vertical lift stand 1 being in an elevated position and with a hunting blind 40 being mounted on the deck 4. The hunting blind 40 will typically have sides, windows, and an entry for ingress and egress to the inside of the hunting blind 40. A ladder 39 can also be attached to the back of the frame 5 for easy access to the hunting blind 40.

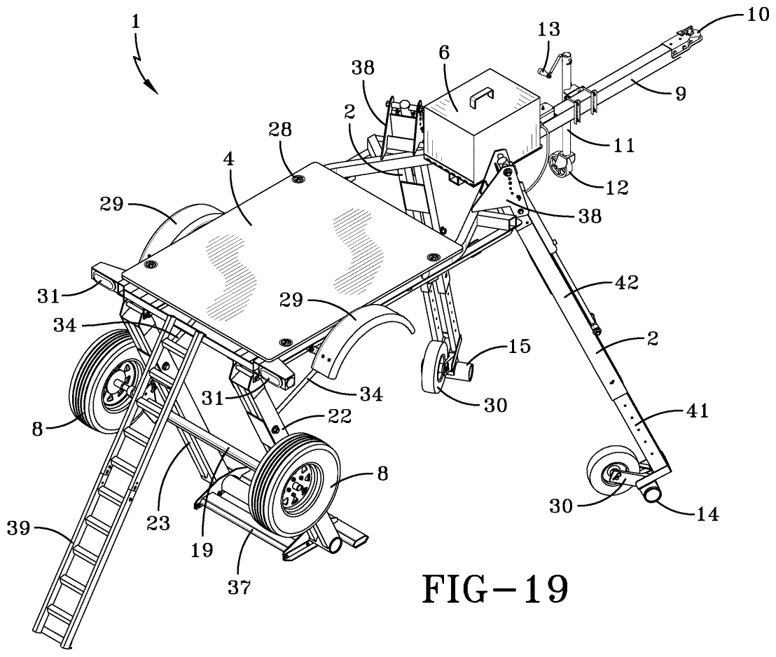

FIG. 19 is a top right side perspective view of the mobile vertical lift 1 with the deck 4 of the mobile vertical lift 1 stand being in an elevated position and with the front legs 2 and the back legs 3 of the mobile vertical lift stand 1 being in a fully extended position. In this embodiment of the invention, a hunting blind 40 is on the deck 4 of the mobile vertical lift stand 1. This view also shows front legs 2 which have in inside element 41 which is capable of telescoping out of an outside element 42 to control the length of the front legs 2 which provides the lift 1 with the ability to compensate for the grade of surfaces which are not level.

While certain representative embodiments and details have been shown for the purpose of illustrating the subject invention, it will be apparent to those skilled in this art that various changes and modifications can be made therein without departing from the scope of the subject invention.

What is claimed is:

1. A towable vertical lift comprising a frame, wherein the frame has an upper side, a lower side, a front end and a back end; a deck which is affixed to the upper side of the frame; a first back leg; a second back leg; a first front leg; a second front leg; an articulating rear foot which extends from the bottom of the first back leg to the bottom of the second back leg; a first wheel which is attached to the first back leg; a second wheel which is attached to the second back leg; a towing tongue having a first end which is affixed to the front of the frame and a second end having a ball hitch affixed thereto; a first linear actuator with is attached to the frame and to the first back leg; a second linear actuator which is attached to the frame and to the second back leg; a third linear actuator which is attached to the frame and to the first front leg; and a fourth linear actuator which is attached to the frame and to the second front leg.

2. The towable vertical lift of claim 1 wherein the first actuator, the second actuator, the third actuator, and the fourth actuator are hydraulic rams.

3. The towable vertical lift of claim 2 wherein the hydraulic rams are comprised of a cylinder and a rod.

4. The towable vertical lift of claim 1 wherein the first actuator, the second actuator, the third actuator, and the fourth actuator are worm gears actuators.

5. The towable vertical lift of claim 2 which is further comprised of a hydraulic power supply, wherein the hydraulic power supply is comprised of a hydraulic pump, a hydraulic fluid reservoir, and a battery.

6. The towable vertical lift of claim 1 which is further comprised of a torsion axel which extends between the first wheel and the second wheel and which is attached to the first back leg and the second back leg.

7. The towable vertical lift of claim 1 wherein the frame is comprised of a right side support, a left side support, and a plurality of cross members.

8. The towable vertical lift of claim 1 wherein a hunting blind is affixed to the deck.

9. A towable vertical lift which is comprised of a frame, a deck which is affixed to the top of the frame, two front legs, two back legs, and wheels which are affixed to the frame, wherein the two front legs are attached to the frame with hinges which allow for the front legs to swivel from an upward position to a downward position, and wherein the back legs are attached to the frame with hinges which allow for the back legs to swivel from an upward position to a downward position.

10. The towable vertical lift of claim 9 which is further comprised of linear actuators which are attached to the frame and the front legs and linear actuators which are attached to the frame and the back legs.

11. The towable vertical lift of claim 10 wherein the front legs are adapted to be variable in length.

12. The towable vertical lift of claim 11 wherein the front legs have an inside element and an outside element, wherein the inside element is configured to telescope in and out of the outside element.

13. The towable vertical lift of claim 12 wherein the front legs are further comprised of linear actuators which are configured to adjust the length of the front legs.

14. The towable vertical lift of claim 10 which further comprises an articulating rear foot which connects the back legs.

15. The towable vertical lift of claim 10 wherein the front legs include feet and articulating castors.

16. The towable vertical lift of claim 10 wherein a blind is affixed to the top of the deck.

17. A towable vertical lifting hunting blind which is comprised of a frame, a deck, blind housing, a towing tongue, two wheels, and a means for raising and lowering the deck.

18. The towable vertical lifting hunting blind of claim 17 which further comprises linear actuators which are adapted for raising and lowering the deck.

19. The towable vertical lifting hunting blind of claim 18 wherein the linear actuators are hydraulic rams.

20. The towable vertical lifting hunting blind of claim 18 wherein the blind housing includes four sides, windows, at least one door, and a top.
